(19) United States
(12) Patent Application Publication
(10) Pub. No.: US 2026/0227571 A1
(43) Pub. Date: Aug. 6, 2026

(54) COATING STRIPPING DEVICE

(71) Applicant: Fujikura Ltd., Tokyo (JP)

(72) Inventors: Sanga Sakanishi, Sakura-shi (JP); Yoshihiko Toda, Yamaga-shi (JP)

(73) Assignee: Fujikura Ltd., Tokyo (JP)

(21) Appl. No.: 19/159,174

(22) PCT Filed: Feb. 28, 2024
(86) PCT No.: PCT/JP2024/007413

§ 371 Date: Aug. 22, 2025

(30) Foreign Application Priority Data
Feb. 28, 2023 (JP) 2023-029608

(51) Int. Cl. G02B 6/245

(52) U.S. Cl. CPC G02B 6/245

(57) ABSTRACT

A coating stripping device that strips a coating of an optical fiber, includes: a pair of blade bodies that cuts the coating by pinching the optical fiber between the pair of blade bodies in a facing direction; and a stage contiguous to one of the pair of blade bodies in an axial direction intersecting the facing direction and that has a placement surface on which the optical fiber extending in the axial direction from the pair of blade bodies is placed. The placement surface is configured to move relative to the pair of blade bodies in a first adjustment direction intersecting the placement surface.

### TECHNICAL FIELD

The present invention relates to a coating stripping device.

Priority is claimed on Japanese Patent Application No. 2023-29608, filed in Japan on Feb. 28, 2023, the content of which is incorporated herein by reference.

### BACKGROUND

Patent Document 1 discloses a coating stripping device that strips a coating of an optical fiber. The coating stripping device includes a pair of blade bodies that makes a cut in the coating by pinching the optical fiber, and a stage (heating-side main body) disposed contiguous to the rear of the pair of blade bodies. The stage has a placement surface (heater portion) on which the optical fiber is placed.

### PATENT LITERATURE

### PTL 1

Japanese U.S. Pat. No. 6154973

In the coating stripping device as described above, in order to easily strip the coating, it is desirable that the blade bodies and the placement surface have a positional relationship in which a central axis of the optical fiber placed on the placement surface and the center of a gap between the pair of blade bodies coincide with each other. The reason is that when the blade bodies and the placement surface are not in such a positional relationship, the optical fiber is bent in the vicinity of the blade bodies and the coating becomes difficult to strip. However, for example, when the blade bodies are replaced for the purpose of dealing with various coating diameters, there is a possibility that the above-described positional relationship is disrupted depending on the shape of the blade bodies after replacement.

### SUMMARY

One or more embodiments of the present invention provide a coating stripping device in which a positional relationship between blade bodies and a placement surface of an optical fiber is adjustable.

According to a first aspect of the present invention, there is provided a coating stripping device that strips a coating of an optical fiber, the device including: a pair of blade bodies configured to include a first blade body and a second blade body, and to make a cut in the coating by pinching the optical fiber between the first blade body and the second blade body in a facing direction; and a stage provided contiguous to the second blade body in an axial direction intersecting the facing direction, and having a placement surface on which the optical fiber extending from the pair of blade bodies in the axial direction is placed. The placement surface is configured to be relatively movable relative to the pair of blade bodies in a first adjustment SUBSTITUTE SPECIFICATION direction intersecting the placement surface.

According to the first aspect of the present invention, the positional relationship between the blade bodies and the placement surface is adjustable by moving the placement surface relative to the blade bodies.

In addition, according to a second aspect of the present invention, the coating stripping device according to the first aspect further includes a pressing portion configured to press the optical fiber against the placement surface. The placement surface is a heater surface that comes into contact with the coating to heat the coating.

According to the second aspect of the present invention, even when the pressing portion presses the optical fiber, contact between the blade bodies and a bare wire portion can be prevented by adjusting the positional relationship between the blade bodies and the placement surface.

In addition, according to a third aspect of the present invention, the coating stripping device according to the first or second aspect further includes a grip unit configured to grip the optical fiber, and to be relatively movable relative to the pair of blade bodies in the axial direction.

According to the third aspect of the present invention, the stripping of the coating of the optical fiber can be easily performed.

In addition, according to a fourth aspect of the present invention, in the coating stripping device according to any one of the first to third aspects, at least one of the first blade body and the second blade body is replaceable.

According to the fourth aspect of the present invention, the coating stripping device can deal with a plurality of types of optical fibers of which coatings have different diameters.

In addition, according to a fifth aspect of the present invention, the coating stripping device according to any one of the first to fourth aspects further includes an adjustment member configured to have a first sliding surface, and to be movable in a second adjustment direction intersecting the first adjustment direction. The stage has a second sliding surface that slides on the first sliding surface when the adjustment member moves in the second adjustment direction. The first sliding surface and the second sliding surface are inclined with respect to the second adjustment direction such that the placement surface moves in the first adjustment direction when the adjustment member moves in the second adjustment direction and the first sliding surface and the second sliding surface slide.

According to the fifth aspect of the present invention, a configuration in which the placement surface moves in the first adjustment direction can be easily realized.

In addition, according to a sixth aspect of the present invention, the coating stripping device according to the fifth aspect further includes an adjustment screw configured to drive the adjustment member to move in the second adjustment direction.

According to the sixth aspect of the present invention, fine adjustment of the movement amount of the adjustment member and the placement surface is facilitated.

In addition, according to a seventh aspect of the present invention, in the coating stripping device according to the fifth or sixth aspect, when an inclination angle of the first sliding surface with respect to the second adjustment direction is d, d is greater than 0° and equal to or less than 10°.

According to the seventh aspect of the present invention, fine adjustment of the position of the placement surface is facilitated.

According to the aspects of the present invention, it is possible to provide the coating stripping device in which the positional relationship between the blade bodies and the placement surface of the optical fiber is adjustable.

### BRIEF DESCRIPTION OF THE DRAWINGS

FIG. 1 is a perspective view showing a coating stripping device according to one or more embodiments of the present invention.

FIG. 2A is a cross-sectional view taken along line IIA-IIA shown in FIG. 1, and is a view showing a state before a positional relationship between a blade body and a placement surface is adjusted.

FIG. 2B is a view showing a state after the positional relationship between the blade body and the placement surface is adjusted.

### DETAILED DESCRIPTION

Hereinafter, a coating stripping device according to one or more embodiments of the present invention will be described with reference to the drawings.

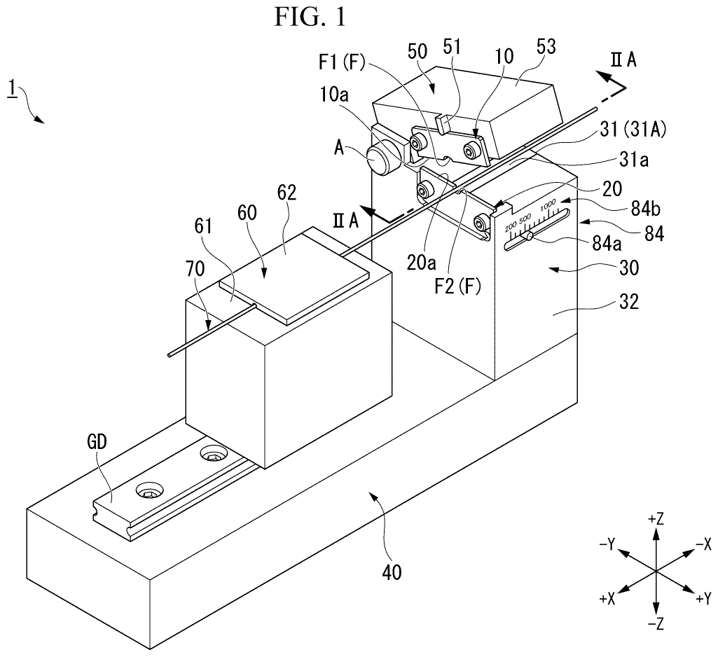

As shown in FIG. 1, a coating stripping device 1 according to one or more embodiments includes a pair of blade bodies 10 and 20 (a first blade body 10 and a second blade body 20), a heating unit 30, a base 40, a rotary lid portion 50, and a grip unit 60 (i.e., grip).

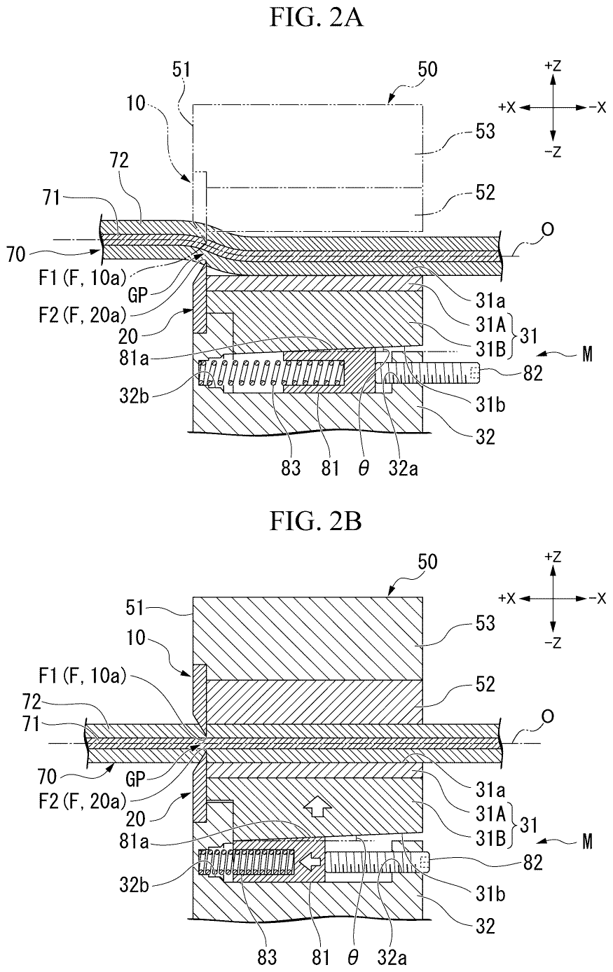

The coating stripping device 1 is used, for example, for an optical fiber 70 as shown in FIGS. 2A and 2B. The optical fiber 70 in the shown example includes a bare wire portion 71 and a coating 72. The bare wire portion 71 includes, for example, a core and a cladding. The coating 72 is an epoxy resin or an acrylic resin that covers the bare wire portion 71. The coating stripping device 1 is a device that strips the coating 72 of the optical fiber 70 using the first blade body 10 and the second blade body 20.

As shown in FIGS. 1, 2A, and 2B, each of the blade bodies 10 and 20 has a flat plate shape. The first blade body 10 includes a first facing edge 10a. The second blade body 20 includes a second facing edge 20a.

The coating stripping device 1 (blade bodies 10 and 20) according to one or more embodiments can take two states: a closed state and an open state. The closed state is a state where the first facing edge 10a (first blade body 10) and the second facing edge 20a (second blade body 20) pinch the optical fiber 70 (refer to FIG. 2B). The open state is a state where the first facing edge 10a and the second facing edge 20a do not face each other and the first facing edge 10a and the second facing edge 20a do not pinch the optical fiber 70. Hereinafter, unless otherwise specified, the positional relationship of each member when the coating stripping device 1 (blade bodies 10 and 20) is in the closed state will be described.

### Definition of Direction

In the present specification, a direction in which the first blade body 10 (first facing edge 10a) and the second blade body 20 (second facing edge 20a) pinch the optical fiber 70 is referred to as a facing direction Z. The facing direction Z is also a direction in which the first blade body 10 (first facing edge 10a) and the second blade body 20 (second facing edge 20a) face each other in the closed state. The facing direction Z is, for example, a vertical direction parallel to gravity. However, the facing direction Z may be inclined with respect to the vertical direction. One direction intersecting (for example, orthogonal to) the facing direction Z is referred to as an axial direction X. A direction intersecting (for example, orthogonal to) both the facing direction Z and the axial direction X is referred to as an intersecting direction Y. In one or more embodiments, the axial direction X is also a thickness direction of the blade bodies 10 and 20 (a direction intersecting the blade bodies 10 and 20) formed in a flat plate shape, and the intersecting direction Y and the facing direction Z are also a direction in which the blade bodies 10 and 20 extend. In addition, a direction from the second blade body 20 toward the first blade body 10 along the facing direction Z is referred to as the +Z direction or upward. The direction opposite to the +Z direction is referred to as a −Z direction or downward. One direction along the intersecting direction Y is referred to as a +Y direction or rightward. The direction opposite to the +Y direction is referred to as a −Y direction or leftward. One direction along the axial direction X is referred to as a +X direction or forward. The direction opposite to the +X direction is referred to as a −X direction or rearward.

As shown in FIG. 1, a first concave blade portion F1 is formed at the first facing edge 10a. The first concave blade portion F1 has a shape that is recessed upward from the first facing edge 10a. The first concave blade portion F1 has, for example, a U shape (semicircular shape) when viewed in the axial direction X. A second concave blade portion F2 is formed at the second facing edge 20a. The second concave blade portion F2 has a shape that is recessed downward from the second facing edge 20a. The second concave blade portion F2 has, for example, a U shape (semicircular shape) when viewed in the axial direction X. The concave blade portions F1 and F2 pinch the optical fiber 70 in the facing direction Z and make a cut in the coating 72.

In the closed state of the coating stripping device 1, the concave blade portions F1 and F2 face each other in the facing direction Z to form one opening portion F. In other words, a gap GP in which the optical fiber 70 is disposed is formed between the concave blade portions F1 and F2. The pair of blade bodies 10 and 20 are formed such that an inner diameter of the opening portion F (gap GP) is smaller than the coating 72 of the optical fiber 70 and is larger than an outer diameter of the bare wire portion 71 (also refer to FIG. 2B).

As shown in FIGS. 1, 2A, and 2B, the heating unit 30 according to one or more embodiments includes a stage 31 and a heating unit base 32. The stage 31 is provided contiguous to the second blade body 20 in the axial direction X. More specifically, the stage 31 is provided contiguous to the rear of the second blade body 20. An upper surface of the stage 31 is a placement surface 31a. The optical fiber 70 extending from the pair of blade bodies 10 and 20 in the axial direction (rearward) is placed on the placement surface 31a.

As shown in FIG. 1, the heating unit base 32 is located on the base 40 and is fixed to a rear end portion of the base 40. The second blade body 20 is fixed to a front surface of the heating unit base 32. Means for fixing the second blade body 20 to the heating unit base 32 is not particularly limited, and for example, screwing can be adopted.

As shown in FIGS. 2A and 2B, the stage 31 according to one or more embodiments includes a heater 31A and an accommodation portion 31B. The accommodation portion 31B accommodates the heater 31A such that the heater 31A is exposed to the upper surface of the stage 31. The heater 31A heats and softens the coating 72 of the optical fiber 70. In one or more embodiments, the placement surface 31a described above is a heater surface that comes into contact with the coating 72 to heat the coating 72.

The rotary lid portion 50 includes a blade body pressing portion 51, a fiber pressing portion (pressing portion) 52 (i.e., press), and a lid portion base 53. The blade body pressing portion 51, the fiber pressing portion 52, and the lid portion base 53 are fixed to each other.

As shown in FIG. 1, the lid portion base 53 is connected to the heating unit 30 (heating unit base 32) via a shaft body A. Accordingly, the rotary lid portion 50 is configured to be able to rotationally move with respect to the heating unit 30 (heating unit base 32) with the shaft body A as a rotation axis. In addition, the first blade body 10 is fixed to a front surface of the lid portion base 53. Means for fixing the first blade body 10 to the lid portion base 53 is not particularly limited, and for example, screwing can be adopted. In one or more embodiments, the rotary lid portion 50 rotationally moves with respect to the heating unit 30, thereby performing switching between the open state and the closed state described above.

As shown in FIGS. 2A and 2B, the fiber pressing portion 52 is fixed to a lower surface of the blade body pressing portion 51. The fiber pressing portion 52 presses the optical fiber 70 against the placement surface 31a. The fiber pressing portion 52 may be, for example, an elastic body (plate-shaped rubber or the like) that elastically presses the optical fiber 70 against the placement surface 31a. The blade body pressing portion 51 is fixed to the front surface of the lid portion base 53.

The blade body pressing portion 51 presses the first blade body 10 toward the second blade body 20 (downward). Although not shown in detail, the blade body pressing portion 51 may include a biasing member that biases the first blade body 10 downward. In this case, the blade body pressing portion 51 applies a downward elastic pressing force (biasing force) to the first blade body 10. The blade body pressing portion 51 and the first concave blade portion F1 may be at substantially the same position in the intersecting direction Y.

The blade body pressing portion 51 may be omitted as long as the first blade body 10 can be pressed toward the second blade body 20 by fixing means (screw or the like described above) for fixing the first blade body 10 to the lid portion base 53. However, the first blade body 10 may be elastically pressed toward the second blade body 20 by the blade body pressing portion 51 since the pinching force with which the blade bodies 10 and 20 (concave blade portions F1 and F2) pinch the optical fiber 70 is easily made uniform by the configuration.

As shown in FIG. 1, the grip unit 60 grips the optical fiber 70. The grip unit 60 is disposed in front of the blade bodies 10 and 20. The grip unit 60 is configured to be linearly movable in the axial direction X. Accordingly, the grip unit 60 is configured to be movable relative to the blade bodies 10 and 20 in the axial direction X. The grip unit 60 according to one or more embodiments linearly moves in the axial direction X along a linear motion guide GD provided on an upper surface of the base 40. The grip unit 60 in the shown example includes a base portion 61 that linearly moves along the linear motion guide GD, and a lid portion 62 that grips the optical fiber 70, together with the base portion 61. However, the configuration of the grip unit 60 can be changed as appropriate.

At least one of the first blade body 10 and the second blade body 20 (for example, both the first blade body 10 and the second blade body 20) may be replaceable. According to this configuration, the shape of the gap GP formed between the blade bodies 10 and 20 can be changed by replacing the blade bodies 10 and 20. Accordingly, the coating stripping device 1 can deal with a plurality of types of the optical fibers 70 of which the coatings 72 have different diameters.

When the coating 72 of the optical fiber 70 is stripped using the coating stripping device 1 according to one or more embodiments, as shown in FIGS. 1 and 2A, first, the coating stripping device 1 is set to the open state. Then, the optical fiber 70 gripped by the grip unit 60 is placed on the second concave blade portion F2 of the second blade body 20. At this time, a portion of the optical fiber 70, which extends rearward from the second blade body 20, is placed on the placement surface (heater surface) 31a of the stage 31. When the optical fiber 70 is gripped by the grip unit 60, a sufficiently long portion of the optical fiber 70, which comes into contact with the placement surface 31a, can be ensured.

Next, the rotary lid portion 50 is closed to cause the coating stripping device 1 to transition to the closed state. In a case where the positional relationship between the blade bodies 10 and 20 and the placement surface 31a is appropriate, as shown in FIG. 2B, the blade bodies 10 and 20 come into contact with only the coating 72 of the optical fiber 70 and make a cut in the coating 72. The expression “a case where the positional relationship between the blade bodies 10 and 20 and the placement surface 31a is appropriate” refers to a case where the center of the gap GP between the blade bodies 10 and 20 and a central axis O of the optical fiber 70 placed on the placement surface 31a coincide with each other.

In addition, at this time, the fiber pressing portion 52 presses the optical fiber 70 against the placement surface 31a. Accordingly, the coating 72 is heated by the placement surface 31a that is a heater surface, thereby softening the coating 72 and weakening adhesion between the coating 72 and the bare wire portion 71. In this state, by separating the grip unit 60 from the blade bodies 10 and 20 in the axial direction X (forward), the coating 72 is torn at a position where the blade bodies 10 and 20 make a cut, and the torn coating 72 is stripped from the optical fiber 70. Then, the bare wire portion 71 is exposed at a portion of the optical fiber 70 from which the coating 72 is stripped.

Here, in a case where the positional relationship between the blade bodies 10 and 20 and the placement surface 31a is not appropriate as shown in FIG. 2A, when the rotary lid portion 50 is closed, the optical fiber 70 is bent by a difference in level between the blade bodies 10 and 20 and the placement surface 31a. When the optical fiber 70 is bent, there is a possibility that the coating 72 cannot be easily stripped. The expression “a case where the positional relationship between the blade bodies 10 and 20 and the placement surface 31a is not appropriate” refers to a case where the center of the gap GP between the blade bodies 10 and 20 and the central axis O of the optical fiber 70 placed on the placement surface 31a do not coincide with each other. Particularly, when the blade bodies 10 and 20 are replaceable, the appropriate position of the placement surface 31a is changed according to the shape of the blade bodies 10 and 20. For that reason, even in a case where the position of the placement surface 31a is optimized for certain blade bodies 10 and 20, a situation where the position of the placement surface 31a becomes inappropriate for the blade bodies 10 and 20 after replacement may occur.

Therefore, in the coating stripping device 1 according to one or more embodiments, an adjustment mechanism M that adjusts the position of the stage 31 (placement surface 31a) in the facing direction Z is provided between the accommodation portion 31B and the heating unit base 32 in the facing direction Z. Namely, the stage 31 (placement surface 31a) is configured to be relatively movable relative to the pair of blade bodies 10 and 20 in the facing direction Z by the action of the adjustment mechanism M.

By providing the adjustment mechanism M, the positional relationship between the blade bodies 10 and 20 and the placement surface 31a is adjustable. Therefore, even when the blade bodies 10 and 20 are replaceable, the position of the placement surface 31a is adjustable according to the shape of the blade bodies 10 and 20. Hereinafter, a specific configuration of the adjustment mechanism M will be described.

The adjustment mechanism M according to one or more embodiments includes an adjustment member 81, an adjustment screw 82, and a biasing member 83. The adjustment member 81 is configured to be movable in the axial direction X. A first sliding surface 81a is provided on an upper surface of the adjustment member 81. When the adjustment member 81 moves in the axial direction X, the adjustment member 81 slides on a second sliding surface 31b provided on a lower surface of the stage 31.

The first sliding surface 81a and the second sliding surface 31b are inclined surfaces inclined with respect to the facing direction Z. More specifically, the first sliding surface 81a and the second sliding surface 31b according to one or more embodiments are inclined downward as the first sliding surface 81a and the second sliding surface 31b extend forward. With this configuration, when the adjustment member 81 moves in the axial direction X and the first sliding surface 81a and the second sliding surface 31b slide, the stage 31 (placement surface 31a) moves in the facing direction Z. Namely, when the adjustment member 81 moves forward, the stage 31 (placement surface 31a) moves upward, and when the adjustment member 81 moves rearward, the stage 31 (placement surface 31a) moves downward. Namely, the sliding surfaces 81a and 31b link the movement of the adjustment member 81 in the axial direction X and the movement of the stage 31 (placement surface 31a) in the facing direction Z.

A movement distance of the stage 31 (placement surface 31a) may be sufficiently small with respect to a movement distance of the adjustment member 81. Accordingly, the position of the stage 31 (placement surface 31a) is finely adjustable (for example, in unit of μm), and for example, a very small difference in the diameter of the bare wire portion 71 can be dealt with. When the inclination angle of the first sliding surface 81a (second sliding surface 31b) with respect to the axial direction X is d, for example, such fine adjustment can be easily performed by setting d greater than 0° and equal to or less than 10°.

The biasing member 83 biases the adjustment member 81 rearward. The type of the biasing member 83 is not particularly limited, and for example, a coil spring can be used as the biasing member 83. In the shown example, a front end portion of the adjustment member 81 is fixed inside a fixing recessed portion 32b formed in the heating unit base 32. The adjustment screw 82 is screwed from the rear into a screw hole 32a that is open on a rear surface of the heating unit base 32. Then, a front end of the adjustment screw 82 is in contact with a rear surface of the adjustment member 81. The adjustment screw 82 drives the movement of the adjustment member 81 in the axial direction X.

When the screwing of the adjustment screw 82 proceeds, the front end of the adjustment screw 82 moves the adjustment member 81 forward against the elastic restoring force of the biasing member 83. On the other hand, when the screwing of the adjustment screw 82 is loosened, the adjustment screw 82 moves backward. Here, since the adjustment member 81 is biased rearward by the elastic restoring force of the biasing member 83, the adjustment member 81 moves backward while the front end of the adjustment screw 82 is in contact with the rear surface of the adjustment member 81. Namely, the biasing member 83 and the screw hole 32a link the rotation of the adjustment screw 82 and the movement of the adjustment member 81 in the axial direction X. By using the adjustment screw 82 in such a manner, the movement amount of the adjustment member 81 and the stage 31 (placement surface 31a) is more finely adjustable.

In addition, as shown in FIG. 1, the coating stripping device 1 according to one or more embodiments includes an adjustment display 84 exposed to the outside of the coating stripping device 1. An operator can adjust the position of the placement surface 31a to a desired position by rotating the adjustment screw 82 while referring to the adjustment display 84. The adjustment display 84 in the shown example is provided on a side surface (surface facing the intersecting direction Y) of the heating unit 30 (heating unit base 32). However, the position where the adjustment display 84 is provided can be changed as appropriate.

The adjustment display 84 in the shown example includes a pin 84a and scales 84b. The pin 84a moves in the axial direction X in link with the rotation of the adjustment screw 82. Namely, the movement of the pin 84a is linked with the movement of the stage 31 (placement surface 31a) in the facing direction Z and the movement of the adjustment member 81 in the axial direction X.

The scales 84b are provided along a region where the pin 84a moves (in the shown example, an elongated hole which extends in the axial direction X and into which the pin 84a is inserted). The number of the scales 84b may correspond to an outer diameter of the coating 72. For example, when the coating stripping device 1 is used for the optical fiber 70 with the coating 72 having an outer diameter of 500 μm, the operator rotates the adjustment screw 82 to align the position of the pin 84a with the position of a line (scale line) marked with the number “500”. Accordingly, the position of the placement surface 31a is adjusted to a position on the optical fiber 70 with the coating 72 having an outer diameter of 500 μm, at which the stripping of the coating 72 is satisfactorily performed. The configuration of the adjustment display 84 can be changed as appropriate as long as the operator can adjust the position of the placement surface 31a to a desired position by referring to the adjustment display 84. In addition, the coating stripping device 1 may not include the adjustment display 84.

The stage 31 (placement surface 31a) may be movable only in the facing direction Z and the adjustment member 81 may be movable only in the axial direction X. According to this configuration, the movement of the stage 31 (placement surface 31a) or the adjustment member 81 in an unintended direction can be restricted.

In addition, the adjustment mechanism M described above is merely one example, and can be changed as appropriate as long as the stage 31 (placement surface 31a) is relatively movable relative to the pair of blade bodies 10 and 20 in the facing direction Z. For example, the adjustment mechanism M may not include the biasing member 83. Even in this case, for example, by forming a screw hole in the adjustment member 81 and screwing the screw hole and the adjustment screw 82, the fine adjustment of the position of the adjustment member 81 by the adjustment screw 82 can be performed. In addition, for example, when the elastic restoring force of the biasing member 83 is sufficiently strong, the first sliding surface 81a and the second sliding surface 31b may be inclined upward as the first sliding surface 81a and the second sliding surface 31b extend forward.

In addition, in the example described above, the stage 31 (placement surface 31a) moves in the facing direction Z; however, a direction in which the stage 31 (placement surface 31a) moves (hereinafter, referred to as a first adjustment direction) may not be the facing direction Z. For example, when the blade bodies 10 and 20 pinch the optical fiber 70 in a horizontal direction (namely, when the facing direction Z is a horizontal direction), the first adjustment direction may intersect the facing direction Z. The first adjustment direction is not particularly limited as long as the first adjustment direction is a direction intersecting the placement surface 31a of the stage 31.

Similarly, in the example described above, the adjustment member 81 moves in the axial direction X; however, a direction in which the adjustment member 81 moves (hereinafter, referred to as a second adjustment direction) may not be the axial direction X. For example, the second adjustment direction may be the intersecting direction Y. The second adjustment direction is not particularly limited as long as the second adjustment direction is a direction intersecting the first adjustment direction.

As described above, according to one or more embodiments, there is provided a coating stripping device 1 that strips a coating 72 of an optical fiber 70, the device including: a pair of blade bodies 10 and 20 that includes a first blade body 10 and a second blade body 20, and that makes a cut in the coating 72 by pinching the optical fiber 70 between the first blade body 10 and the second blade body 20 in a facing direction Z; and a stage 31 provided contiguous to the second blade body 20 in an axial direction X intersecting the facing direction Z, and having a placement surface 31a on which the optical fiber 70 extending from the pair of blade bodies 10 and 20 in the axial direction X is placed. The placement surface 31a is configured to be relatively movable relative to the pair of blade bodies 10 and 20 in a first adjustment direction (for example, the facing direction Z) intersecting the placement surface 31a. Namely, the coating stripping device 1 includes an adjustment mechanism M.

With this configuration, the positional relationship between the blade bodies 10 and 20 and the placement surface 31a is adjustable by moving the placement surface 31a relative to the blade bodies 10 and 20.

In addition, the coating stripping device 1 according to one or more embodiments further includes a fiber pressing portion (pressing portion) 52 that presses the optical fiber 70 against the placement surface 31a. The placement surface 31a is a heater surface that comes into contact with the coating 72 to heat the coating 72. In the coating stripping device in which the optical fiber 70 is pressed against the placement surface 31a (heater surface), in a case where the positional relationship between the blade bodies 10 and 20 and the placement surface 31a is inappropriate, the possibility of the blade bodies 10 and 20 coming into contact with a bare wire portion 71 is increased. The reason is that the pressing force that the fiber pressing portion 52 applies to the optical fiber 70 can act to bring the optical fiber 70 (bare wire portion 71) and the blade bodies 10 and 20 close to each other. According to the coating stripping device 1 of one or more embodiments, even when the fiber pressing portion 52 presses the optical fiber 70, contact between the blade bodies 10 and 20 and the bare wire portion 71 can be prevented by adjusting the positional relationship between the blade bodies 10 and 20 and the placement surface 31a.

In addition, the coating stripping device 1 according to one or more embodiments further includes a grip unit 60 that grips the optical fiber 70, and that is relatively movable relative to the pair of blade bodies 10 and 20 in the axial direction X. With this configuration, the stripping of the coating 72 of the optical fiber 70 can be easily performed.

In addition, at least one of the first blade body 10 and the second blade body 20 may be replaceable. With this configuration, the shape of a gap GP formed between the blade bodies 10 and 20 can be changed by replacing the blade bodies 10 and 20. Accordingly, the coating stripping device 1 can deal with a plurality of types of the optical fibers 70 of which the coatings 72 have different diameters. In addition, even when the appropriate position of the placement surface 31a is changed by the replacement of the blade bodies 10 and 20, the positional relationship between the blade bodies 10 and 20 and the placement surface 31a can be made appropriate by adjusting the position of the placement surface 31a.

In addition, the coating stripping device 1 according to one or more embodiments further includes an adjustment member 81 that has a first sliding surface 81a, and that is movable in a second adjustment direction (for example, the axial direction X) intersecting the first adjustment direction. The stage 31 has a second sliding surface 31b that slides on the first sliding surface 81a when the adjustment member 81 moves in the second adjustment direction. The first sliding surface 81a and the second sliding surface 31b are inclined with respect to the second adjustment direction such that the placement surface 31a moves in the first adjustment direction when the adjustment member 81 moves in the second adjustment direction and the first sliding surface 81a and the second sliding surface 31b slide. With this configuration, a configuration in which the placement surface 31a moves in the first adjustment direction can be easily realized. In addition, the movement distance of the placement surface 31a with respect to the movement distance of the adjustment member 81 is also adjustable by changing the inclination angle of the sliding surfaces 81a and 31b with respect to the second adjustment direction.

In addition, the coating stripping device 1 according to one or more embodiments further includes an adjustment screw 82 that drives the adjustment member 81 to move in the second adjustment direction. With this configuration, the fine adjustment of the movement amount of the adjustment member 81 and the placement surface 31a is facilitated.

In addition, when an inclination angle of the first sliding surface 81a with respect to the second adjustment direction is d, d is greater than 0° and equal to or less than 10°. With this configuration, the fine adjustment (for example, in unit of μm) of the position of the placement surface 31a is facilitated.

The technical scope of the present invention is not limited to the above-described embodiments, and various changes can be made without departing from the scope of the present invention.

For example, the coating stripping device 1 may be configured to strip a coating of an optical fiber tape (optical fiber ribbon) in which a plurality of the optical fibers 70 arranged in a tape shape are collectively coated with a single coating. In this case, the blade bodies 10 and 20 may not include the concave blade portions F1 and F2. Namely, when viewed in the axial direction X, the facing edges 10a and 20a of the blade bodies 10 and 20 may extend linearly in the intersecting direction Y. The coating of the optical fiber tape may be stripped by disposing the optical fiber tape in the gap GP formed between the facing edges 10a and 20a having a linear shape.

In addition, the grip unit 60 in the above-described embodiments includes the base portion 61 and the lid portion 62, and directly grips the optical fiber 70; however, the configuration of the grip unit 60 is not limited thereto. The configuration may be such that a part of the optical fiber 70 is accommodated in an optical fiber holder having a box shape and the grip unit 60 indirectly grips the optical fiber 70 via the holder. According to this configuration, an appropriate optical fiber holder can be selected according to the diameter of the coating 72, and the central axis O of the optical fiber 70 in the grip unit 60 and the gap GP between the blade bodies 10 and 20 can be set to coincide with each other.

In addition, when the optical fiber 70 is manually pulled out, the coating stripping device 1 may not include the grip unit 60. However, the coating stripping device 1 may include the grip unit 60 in that contact between the blade bodies 10 and 20 and the bare wire portion 71 is less likely to occur compared to when the optical fiber 70 is manually pulled out.

In addition, the placement surface 31a of the stage 31 may not be a heater surface that heats the coating 72. In this case, the coating stripping device 1 may not include the fiber pressing portion 52.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1: Coating stripping device
10: First blade body
20: Second blade body
31: Stage
31a: Placement surface (heater surface)
31b: Second sliding surface
52: Fiber pressing portion (pressing portion)
60: Grip unit
70: Optical fiber
72: Coating
81: Adjustment member
81a: First sliding surface
82: Adjustment screw

1. A coating stripping device that strips a coating of an optical fiber, the device comprising:
a pair of blade bodies that cuts the coating by pinching the optical fiber between the pair of blade bodies in a facing direction; and
a stage contiguous to one of the pair of blade bodies in an axial direction intersecting the facing direction and that has a placement surface on which the optical fiber extending in the axial direction from the pair of blade bodies is placed, wherein
the placement surface is configured to move relative to the pair of blade bodies in a first adjustment direction intersecting the placement surface.

2. The coating stripping device according to claim 1, further comprising:
press configured to press the optical fiber against the placement surface, wherein
the placement surface is a heater surface that comes into contact with the coating and heats the coating.

3. The coating stripping device according to claim 1, further comprising a grip configured to grip the optical fiber and to move relative to the pair of blade bodies in the axial direction.

4. The coating stripping device according to claim 1, wherein at least one of the pair of blade bodies configured to be replaced.

5. The coating stripping device according to claim 1, further comprising:
an adjustment member having a first sliding surface and that is configured to move in a second adjustment direction intersecting the first adjustment direction by sliding a second sliding surface of the stage on the first sliding surface, wherein
the first sliding surface and the second sliding surface are inclined with respect to the second adjustment direction such that the placement surface moves in the first adjustment direction in response to the adjustment member moving in the second adjustment direction. slide.

6. The coating stripping device according to claim 5, further comprising an adjustment screw configured to drive the adjustment member and to move in the second adjustment direction.

7. The coating stripping device according to claim 5, wherein an inclination angle of the first sliding surface with respect to the second adjustment direction is greater than 0° and equal to or less than 10°.
